(19) United States
(12) Patent Application Publication
(10) Pub. No.: US 2014/0370299 A1
(43) Pub. Date: Dec. 18, 2014

(54) MULTILAYER SYSTEMS

(71) Applicant: LANXESS Deutschland GmbH, Cologne (DE)

(72) Inventors: Stefan Kelbch, Much (DE); Olaf Isenburg-Schulz, Langenfeld (DE)

(21) Appl. No.: 14/363,019

(22) PCT Filed: Jan. 22, 2013
(86) PCT No.: PCT/EP2013/051146

§ 371 Date: Jun. 5, 2014

(30) Foreign Application Priority Data
Jan. 26, 2012 (EP) 12152698.2

(51) Int. Cl. B32B 25/04; B32B 37/24; B32B 27/30; B05D 7/00; B32B 25/16; B32B 25/14

(52) U.S. Cl. CPC B32B 25/042; B32B 25/16; B32B 25/14; B32B 27/306; B32B 27/304; B32B 27/308; B05D 7/52; B32B 37/24; B32B 2405/00; B32B 2327/12; B32B 2319/00; B32B 2250/02
USPC 428/422; 427/393.5; 427/316; 427/256; 156/242

(57) ABSTRACT

The present invention relates to a multilayer system comprising
(1) a first layer comprising at least one fluororubber, and
(2) a second layer comprising at least one main elastomer material selected from the group consisting of acrylate rubber (ACM), ethylene-acrylate rubber (AEM) and ethylene-vinyl acetate copolymers (EVM) and combinations thereof.

The present invention relates to multilayer systems which comprise a fluororubber and a main elastomer material, and to a process for producing the same.

Fluorine-containing polymers (i.e. fluoro polymers or fluorinated polymers) are an important class of polymers featuring high heat resistance and chemicals resistance, for example solvent resistance. Fluoro elastomers, in particular the copolymers of vinylidene fluoride with other ethylenically unsaturated, halogenated monomers, such as hexafluoropropylene, are specifically useful in high-temperature applications, for example in gaskets and linings. Multilayer structures which comprise a fluorinated polymer are used by way of example in fuel-line hoses and similar vessels.

Vulcanization products of fluoro polymers (fluororubbers) have good heat resistance, chemicals resistance, oil resistance and weathering resistance, and they are therefore widely used as sealing materials, e.g. flat gaskets, O rings, oil gaskets, and generally gaskets in the sectors of the automobile industry and the oil-hydraulics industry, and also of general mechanical industry. However, it is not always possible to process fluoronibber with various metals or plastics to give composite structures that are required in many usage sectors in industry. The prior art has therefore proposed a large number of processes and binders for ensuring satisfactory bonds between various metals or plastics and fluoro elastomers.

A precondition in the production of oil gaskets by way of example is vulcanization-induced adhesion between the fluororubber and metals or plastics. It is known from the prior art that, in order to comply with this precondition, by way of example, a silane adhesive or the like can be applied to phosphate-coated steel sheet, and this can then be stoved, and an unvulcanized fluororubber compound can be applied thereto and a vulcanization process can then be carried out under pressure.

JP-A-3-37251 describes a fluorinated elastomer composition which comprises a terpolymer elastomer rubber made of vinylidene fluoride/tetrafluoroethylene/hydrocarbon-olefin, a polyhydroxy compound, an organic onium compound and a fluorinated aliphatic sulphonyl compound, where N-substituted terfluoroalkylsulphonamides are used as aliphatic fluorinated sulphonyl compounds, as adhesion promoters.

The prior art also discloses that surface treatment of one or both layers is required in order to bring about the adhesion between fluororubbers and metals or plastics. By way of example, fluoro polymer layers are firstly treated with an ionized gas atmosphere (plasma), and a layer of a second material is then applied thereto.

WO-A-9900455 discloses a process for bonding a fluoro polymer to a non-fluorinated polymer. In the first step here, a composition made of an amine and of a first non-fluorinated polymer is produced, in order to form a polymer with amine functionality; in the second step, this polymer is combined with a second non-fluorinated polymer, and in the third step a multilayer article is formed, where the two-layer non-fluorinated polymer composite from the second step is brought together with a fluoro polymer.

The prior art also discloses a plastics composite with a polyamide resin surface layer and a fluoro resin surface layer.

WO-A-0052084 discloses a mixture of a fluoro polymer, of a primary or secondary di- or polyamine, of an organoonium catalyst and optionally of one or more tackifiers.

DE 196 12 732 discloses by way of example, in order to permit adhesion of fluororubbers on metals, a fluororubber composition which also comprises a crosslinking agent. The crosslinking agent is by way of example diamine.

DE 69814179 discloses by way of example another approach to improvement of adhesion of fluororubbers on metals. Here, the non-fluorinated polymer layer is treated with a base.

DE 69226900 also discloses the addition of a quaternary ammonium salt derivative of a triazinethiol to the fluororubber mixture.

WO 0236705 discloses an adhesive mass based on one or more a-olefin-vinyl acetate polymers. However, it does not give any indication that the said self--adhesive mass is also suitable for fluororubbers.

DE 2005 009 664 is also prior art. Here, a multilayer composite system is described, where the adhesion promoter based on ethylene-vinyl acetate copolymer is used between two films of different chemical structure. Here again, no use is made of coating with, or adhesion to, fluororubbers.

It was therefore an object of the present invention to propose a multilayer system where the fluororubber present therein exhibits reliable adhesion.

The object is achieved via a multilayer system which comprises a first layer comprising at least one fluororubber and a second layer comprising at least one main elastomer material selected from the group consisting of acrylate rubber (ACM), ethylene-acrylate rubber (AEM) and ethylene-vinyl acetate copolymers (EVM) and combinations thereof.

In another preferred embodiment, the second layer is composed of at least one main elastomer material selected from acrylate rubber (ACM), ethylene-acrylate rubber (AEM) and ethylene-vinyl acetate copolymers (EVM) and combinations thereof.

Surprisingly, it has been found that with this combination it was no longer possible to separate the two layers.

Suitable fluororubbers are in principle any of the fluororubbers known to the person skilled in the art. It is preferable that the fluoronibber that can be used according to the invention involves a fluororubber composed of one or more of the following monomers: optionally substituted ethylenes, where these can comprise, alongside fluorine, hydrogen and/or chlorine, e.g. vinylidene fluoride, tetrafluoroethylene and chlorotrifluoroethylene, fluorinated 1-alkenes having from 3 to 8 carbon atoms, e.g. hexafluoropropylene, 3,3,3-trifluoropropylene, chloropentafluoropropylene, hexafluoroisobutene and/or perfluorinated vinyl ethers of the formula

CF₂═CFOX

where X is C₁-C₃-perfluoroalkyl or —(CF₂—CFY—O)ₙ—R_{F},
where
n is from 1 to 4

### Y is F or CF₃ and

R_{F} is C₁-C₃-perfluoroalkyl.

It is preferable that the at least one fluororubber that can be used according to the invention involves a homo-, co- or terpolymer composed of one or more of the abovementioned monomers. It is particularly preferable to use, as monomers, a combination of vinylidene fluoride, hexafluoropropylene and/or tetrafluoroethylene, giving by way of example a copolymer based on vinylidene fluoride and tetrafluoroethylene or a copolymer based on vinylidene fluoride and hexafluoropropylene or a terpolymer based on vinylidene fluoride, tetrafluoroethylene and hexafluoropropylene.

The at least one fluororubber can moreover be composed of—in addition to the abovementioned monomers—the abovementioned perfluorinated vinyl ethers, and a perfluorinated alkyl vinyl ether can be involved here, e.g. perfluoro(methyl vinyl ether).

The composition of the fluoronibbers can comprise, in addition to the above mentioned monomers, at least one monomer suitable for the peroxidic crosslinking process (Cure Site Monomer=CSM), e.g. bromine- or iodine-containing Cure Site monomers, such as BTFB, 4-bromo-3,3,4′,4′-tetrafluorobut-1-ene, BTFE, bromotrifluoroethene, 1-bromo-2,2′-difluoroethene, vinyl bromide, perfluoroallyl bromide, 3,3′-difluoroallyl bromide and 4-bromoperfluorobut-1-ene or corresponding iodine compounds.

Another way of introducing crosslinking iodine/bromine chain ends or iodine/bromine-terminated side chains uses iodine/bromine-containing chain extenders, e.g. CF₃I/CF₃Br or methylene iodide/bromide.

An example of an appropriate fluororubber is a terpolymer based on vinylidene fluoride, tetrafluoroethylene, and hexafluoropropylene and of at least one monomer suitable for the peroxidic crosslinking process.

The monomer suitable for the peroxidic crosslinking process (Cure Site Monomer=CSM) preferably has the following formula:

CF₂═CFHal

where
Hal is Cl, Br or I, preferably Br or I.

The at least one fluororubber can by way of example be obtainable from the following monomeric composition:

from 0 to 90 mol % of vinylidene fluoride,
from 10 to 80 mol % of hexafluoropropylene,
from 0 to 40 mol % of tetrafluoroethylene and
from 0 to 25 mol % of perfluorinated vinyl ethers of the formula

CF₂═CFOX

where
X is C₁-C₃-perfluoroalkyl or —(CF₂—CFY—O)ₙ—R_{F},
where
n is from 1 to 4,

### Y is F or CF₃ and

R_{F} is C₁C₃-perfluoroalkyl, and
from 0 to 25 mol % of a monomer suitable for the peroxidic crosslinking process, where the entirety of the components gives 100 mol %.

It is very particularly preferable that the fluororubber used according to the invention involves a copolymer composed of from 30 to 80 mol % of vinylidene fluoride and from 10 to 40 mol % of hexafluoropropylene, a terpolymer composed of from 30 to 85 mol % of vinylidene fluoride, from 5 to 30 mol % of tetrafluoroethylene and from 10 to 30 mol % of hexafluoropropylene and from 0 to 20 mol % of at least one monomer suitable for the peroxidic crosslinking process, or a terpolymer composed of from 30 to 80 mol % of vinylidene fluoride, from 5 to 30 mol % of tetrafluoroethylene, from 10 to 30 mol % of hexafluoropropylene, from 0 to 30 mol % of perfluorinated alkylvinyl ethers and from 0 to 20 mol % of at least one monomer suitable for the peroxidic crosslinking process, where the entirety of the components of the respective co- or terpolymer in each case gives 100 mol %.

The number-average molar mass of the fluororubber used according to the invention is generally from 25 to 100 kg/mol, preferably from 40 to 80 kg/mol. The polydispersity M_{w}/Mₙ is generally from 1.5 to 10. The number-average molar mass and the weight-average molar mass are determined by means of gel permeation chromatography with THF as eluent (DIN 55672-1).

The Mooney viscosities (ML1+10 at 121° C.) of the fluororubber used according to the invention are generally from 1 to 170, preferably from 10 to 80. Mooney viscosity is determined in accordance with DIN 53523.

The at least one fluororubber used according to the invention is generally produced in accordance with processes known from the prior art. It is preferable that the fluororubber is produced by aqueous emulsion or suspension polymerization (Ullmann's Encyclopedia of Ind. Chem., Vol. A-11, VCH-Verlagsgesellschaft, Weinheim, 1988, p. 417 ff.). It is equally possible to produce the at least one fluororubber used according to the invention in accordance with the process described in DE 19844338 A1.

The fluororubber preferably involves a vulcanized, and particularly preferably heat-conditioned, fluororubber vulcanisate. Very surprisingly, it was possible to bond a fluororubber vulcanisate the second layer made from the main elastomer material according to the invention.

The fluororubber vulcanisate preferably comprises the usual additives, for example fillers (e.g. carbon black or inorganic fillers), processing aids (e.g. fatty amines), plasticizers (e.g. ester plasticizers), metal oxides (e.g. Ca(OH)₂, MgO, ZnO), crosslinking systems (ionic) (e.g. bisphenol AF and onium catalyst) or peroxidic crosslinking systems (e.g. peroxide and TAIC/TAC/TRIM).

The fluorine content of the fluororubber is moreover in the range from 55% by weight to 80% by weight, preferably in the range from 60% by weight to 73% by weight and particularly preferably from 65% by weight to 71% by weight, based on the fluororubber.

Main elastomer material used can comprise ethylene-vinyl acetate copolymer (EVM), acrylate rubbers (ACM) and/or ethylene-acrylate rubber (AEM), where these are free from additions, for example fillers, antioxidants, processing aids, plasticizers, resins, silanes. However, in another embodiment the additions can be present.

An ethylene-vinyl acetate copolymer (EVM) with vinyl acetate content >50% by weight, preferably >60% by weight, based on the ethylene vinyl acetate copolymer, can preferably be used for the multilayer system according to the invention. The viscosity of the ethylene-vinyl acetate copolymers is from 5 to 90 Mooney units, preferably from 15 to 70 Mooney units (Mooney viscosity 1+4 at 100° C.).

The gel content of ethylene-vinyl acetate copolymers that have not been precrosslinked is <2% by weight, preferably <1% by weight. Gel content is measured by dissolving the polymer in toluene (12.5 g/l) for 22 h at 25° C., then ultracentrifuging (2 h, 25° C. at 20 000 revolutions/minute) and carrying out gravimetric determination.

EVMs are preferably produced by means of solution polymerization (Werner Hofmann: Rubber Technology Handbook, Carl Hanser Verlag, ISBN 3446-14895-7, pp. 100ff).

Another possibility is the use of an acrylate rubber (ACM), i.e. copolymers of acrylic esters (e.g. ethyl acrylate, butyl acrylate, ethyl methoxyacrylate or ethyl ethoxyacrylate or a combination thereof), and also crosslinking monomers such as chloroethyl vinyl ether, vinyl chloroacetate, chloromethylacrylic acid or ethyl ester thereof, glycidyl ether, methylol compounds, imido ester, hydroxy acrylates (e.g. beta-hydroxyethyl acrylate), carboxy compounds (e.g. methacrylic acid) or alkylidene norbornene. The ACMs are produced by a known emulsion polymerization process as described for example in Werner Hofmann: Rubber Technology Handbook, Carl Hanser Verlag, ISBN 3-446-14895-7, pp. 107ff.

It is also possible to use an ethylene-acrylate rubber (AEM), a terpolymer made of ethylene and methacrylate with a crosslinking monomer having carboxy groups (e.g. monoethyl maleate) with methacrylate content of from 30% by weight to 80% by weight and with crosslinking monomer content of from 0.5% by weight to 20% by weight. AEM is produced by means of solution polymerization. It is equally possible to produce AEM in accordance with the process described in US2003204025 A1.

One preferred embodiment of the multilayer system according to the invention comprises a first layer made of a fluororubber vulcanisate with fluorine content >60% by weight, preferably greater than 65% by weight, based on the fluororubber; and a second layer formed from an ethylene-vinyl acetate copolymer, where the vinyl acetate content of the ethylene-vinyl acetate copolymer is >50% by weight, based on the ethylene-vinyl acetate copolymer.

The invention also provides for the use of the multilayer system according to the invention for producing adhesive tapes, linings and adhesion systems.

The invention also provides a process for producing the multilayer system according to the invention, where the first layer is produced by vulcanizing the at least one fluororubber and, in the next step, the second layer based respectively on EVM, AEM or ECM and produced by aqueous emulsion or solution polymerization is brought into contact with the first layer.

The vulcanization process can preferably be followed by downstream heat-conditioning.

The contact can be achieved by means of (co)extrusion coating, press coating, solution coating, solution spraying, emulsion coating, or gravure coating. Another possibility is the use of lamination processes or glass/slot extrusion processes or calendering. The second layer is applied here to the first layer.

The layers can preferably be brought into contact at elevated temperature and at elevated pressure.

The invention is explained in more detail below by taking examples:

### EXAMPLES

### 1. Production of the Fluororubber Vulcanisates

To produce a crosslinkable composition, the individual components of the appropriate mixtures specified below are incorporated on a two-roll mixer system with effective cooling within a period of typically 10 min at a roll temperature of 20° C.

### 1.1 FKM Vulcanisates With Bisphenol Crosslinking

Copolymer Mixtures A

100 phr of Levatherm® F. 6623 or 6625¹⁾

30 phr of Luvomaxx® N990²⁾

6 phr of Ca(OH)₂³⁾

3 phr of MgO⁴⁾

4 phr of Levatherm® FC30⁵⁾

2 phr of Levatherm® FC20⁶⁾
1) FILM copolymer composed of vinylidene fluoride and hexafluoropropylene from Lanxess Deutschland GmbH
2) Carbon black from Lehmann & Voss
3) Ca(OH)₂ from Sturge
4) MgO from Rhein Chemie Rheinau GmbH
5) Masterhatch from Lanxess Deutschland GmbH, composed of 50% by weight of bisphenol AF (VWR-Lianyungang) and Levatherm® F 6623
6) Masterbatch from Lanxess Deutschland GmbH, composed of 33% by weight of benzyltriphenylphosphonium chloride (Organica) and Levatherm® F6623

Terpolymer Mixtures B

100 phr of Levatherm® F 6833 or 6836¹⁾

30 phr of Luvomaxx® N990²⁾

6 phr of Ca(OH)₂³⁾

3 phr of MgO⁴⁾

4 phr of Levatherm® FC30⁵⁾

3 phr of Levatherm® FC20⁶⁾
1) FKM terpolymer composed of vinylidene fluoride, hexafluoropropylene and tetrafluoroethylene from Lanxess Deutschland GmbH
2) Carbon black from Lehmann & Voss
3) Ca(OH)₂ from Sturge
4) MgO from Rhein Chemie Rheinau GmbH
5) Masterbatch composed of 50% by weight of bisphenol AF (VWR-Lianyungang and Levatherm® F 6623
6) Masterbatch composed of 33% by weight of benzyltriphenylphosphonium chloride (Organica) and Levatherm® F6623

Terpolymer+CSM: Mixtures C

100 phr of Levatherm® F 7043 or 7046 ¹⁾

30 phr of Luvomaxx® N990 ²⁾

3 phr of Luperox® 101XL45-SP2³⁾

3 phr of TAIC⁴⁾

3 phr of ZnO⁵⁾
1) FKM terpolymer composed of vinylidene fluoride, tetrafluoroethylene and hexafluoropropylene and of a cure site monomer (CSM) from Lanxess Deutschland GmbH
2) Carbon black from Voss
3) Peroxide from Arkema
4) Coactivator, 70% of triallyl isocyanurate from Kettlitz
5) ZnO from Lanxess Deutschland GmbH

The respective mixture is pressure-vulcanized at 120 bar and 177° C. for about 10 minutes in sheet moulds measuring 100×100×2 mm and then post-vulcanized in a convection oven (24 h at 230° C.). The resultant sheets are the first layer.

2. Production of the Second Layer Made of a Main Elastomer Material Composed of EVM, ACM or AEM

The following main elastomer materials were used.

EVM from Lanxess Deutschland GmbH:
Levapren® 400 (40% of vinyl acetate)
Levapren® 500 (50% of vinyl acetate)
Levapren® 600 (60% of vinyl acetate)
Levapren® 700 (70% of vinyl acetate)
Levapren® 800 (80% of vinyl acetate)
Levapren® 900 (90% of vinyl acetate)

ACM from Nippon Zeon:
NipolAR® 12

AEM from DuPont:
Vamac® G
Vamac® GLS
Vamac® DP

The respective pure main elastomer material (EVM, ACM or AEM) was processed on a cold roll system (20° C.) and taken off in the form of a milled rubber sheet; sheets measuring 200×200×1 mm were then pressed between Teflon films at a pressure of 200 bar and 110° C. for 10 minutes. These are respectively the second layer.

3. Production of the Multilayer System According to the Invention

The vulcanized and heat-conditioned fluororubber vulcanisate sheet (first layer) was laminated to the respective EVM, ACM or AEM sheet (second layer). This two-layer system was pressed between Teflon films at a pressure of 120 bar for 10 minutes at 177° C. The resultant multilayer system according to the invention is used for the separation test, using a method based on DIN 53530.

4. Summary of Results

The resistance of the multilayer systems to separation was tested by using a tensile testing machine and a method based on DIN 53530. Each test used two-layer test specimens of length 200 mm, width 25 mm and thickness 2×1 mm, made of the multilayer systems according to the invention.

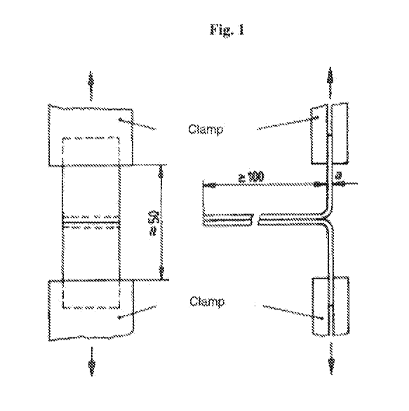

In each case, one layer was clamped into jaws of the tensile machine and subjected to tension according to DIN 53530. FIG. 1 is a diagram of the experimental arrangement for the separation test.

For evaluation purposes, there are only two possible useful classifications:
0: Adhesion unexceptional: i.e. separation of the two-layer test specimens is possible without any observable cohesive failure.
1: No separation possible: i.e. fracture occurs in the second layer (polymer layer made of the main elastomer materials EVM, ACM, AEM).

TABLE 1

| | EVM¹⁾ with vinyl | | | | | | | |
|---|---|---|---|---|---|---|---|---|
| | acetate content [%] | | | | | | | |
| | 40 | 50 | 60 | 70 | 80 | 90 | ACM²⁾ | AEM³⁾ |
| FKM, 66% fluorine | 0 | 1 | 1 | 1 | 1 | 1 | 1 | 1 |
| content, Mixture A | | | | | | | | |
| Levatherm F6623 | | | | | | | | |
| FKM, 66% fluorine | 0 | 1 | 1 | 1 | 1 | 1 | 1 | 1 |
| content, Mixture A | | | | | | | | |
| Levatherm F6625 | | | | | | | | |
| FKM, 68% fluorine | 0 | 1 | 1 | 1 | 1 | 1 | 1 | 1 |
| content, Mixture B | | | | | | | | |
| Levatherm F6833 | | | | | | | | |
| FKM, 68% fluorine | 0 | 1 | 1 | 1 | 1 | 1 | 1 | 1 |
| content, Mixture B | | | | | | | | |
| Levatherm F6836 | | | | | | | | |
| FKM, 70% fluorine | 0 | 0 | 1 | 1 | 1 | 1 | 1 | 1 |
| content, Mixture C | | | | | | | | |
| Levatherm F7043, | | | | | | | | |
| F7046 | | | | | | | | |
| FKM, 70% fluorine | 0 | 0 | 1 | 1 | 1 | 1 | 1 | 1 |
| content, Mixture C | | | | | | | | |
| Levatherm F7046 | | | | | | | | |

¹⁾EVMs with various vinyl acetate contents from Lanxess Deutschland GmbH
²⁾Nipol AR 12 from Nippon Zeon
³⁾Vamac G, GLS, DP from DuPont

As a function of FKM polymer type, inseparable adhesion was found to start at a particular vinyl acetate content (VA content) of the EVM. Levapren 400, VA content 40% by weight, fails to achieve significant adhesion on the fluororubber vulcanisate, but starting at 50% VA content the multilayer systems are found to have inseparable bonding.

At fluorine content greater than 70% by weight, based on the fluororubber, significant adhesion was not found until the VA content of EVM reached 60% by weight (Levapren 600). It cannot therefore be assumed that as the amount of fluorine in the FKM increases, there is also an increase in the VA content required in the EVM in order to permit irreversible adhesion.

The ACM polymer studied, and all three AEM polymers from DuPont were found to give fully satisfactory adhesion.

What is claimed is:

1. Multilayer system comprising
(1) a first layer comprising at least one fluororubber, and
(2) a second layer comprising at least one main elastomer material selected from the group consisting of acrylate rubber (ACM), ethylene-acrylate rubber (AEM) and ethylene-vinyl acetate copolymers (EVM) and combinations thereof.

2. Multilayer system according to claim 1, characterized in that the fluororubber is obtainable from the following monomeric composition:
from 20 to 90 mol % of vinylidene fluoride,
from 10 to 80 mol % of hexafluoropropylene,
from 0 to 40 mol % of tetrafluoroethylene and
from 0 to 25 mol % of perfluorinated vinyl ethers of the formula CF₂═CFOX
where X is C₁-C₃-perfluoroalkyl or —(CF₂—CFY—O)ₙ—R_{F},
where
n is from 1 to 4,
Y is F or CF₃ and
R_{F} is C₁-C₃-perfluoroalkyl, and
from 0 to 25 mol % of a monomer suitable for the peroxidic crosslinking process,
where the entirety of the components gives 100 mol %.

3. Multilayer system according to claim 3, characterized in that the fluororubber involves a vulcanized fluororubber vulcanisate.

4. Multilayer system according to claim 3, characterized in that the fluorine content of the fluororubber is in the range from 55% by weight to 80% by weight, preferably in the range from 60% by weight to 73% by weight and particularly preferably in the range from 65% by weight to 71% by weight, based on the fluororubber.

5. Multilayer system according to claim 4, characterized in that the acrylate rubber is a copolymer comprising at least one acrylate selected from ethyl acrylate, butyl acrylate, ethyl methoxyacrylate and ethyl ethoxyacrylate and combinations thereof, and/or from crosslinking monomers selected from chloroethyl vinyl ether, vinyl chloroacetate, chloromethylacrylic acid and ethyl ester thereof, glycidyl ether, methylol compounds, imido ester, hydroxy acrylates (e.g. beta-hydroxyethyl acrylate), carboxy compounds (e.g. methacrylic acid) and alkylidene norbornene,

6. Multilayer system according to claim 5, characterized in that the ethylene-acrylate rubber (AEM) is a terpolymer of ethylene and methacrylate with a crosslinking monomer having carboxy groups with methacrylate content of from 30% by weight to 80% by weight and with crosslinking monomer content of from 0.5% by weight to 20% by weight.

7. Multilayer system according to claim 6, characterized in that the vinyl acetate content of the ethylene-vinyl acetate copolymer (EVM) is greater than 50% by weight, preferably greater than 60% by weight, based on the ethylene-vinyl acetate copolymer.

8. Multilayer system according to claim 1 comprising
(1) a first layer made of a fluororubber vulcanisate with fluorine content greater than 60% by weight, preferably 65% by weight, based on the fluororubber and
(2) a second layer formed from an ethylene-vinyl acetate copolymer (EVM), where the vinyl acetate content of the ethylene-vinyl acetate copolymer is greater than 50% by weight, based on the ethylene-vinyl acetate copolymer.

9. Use of a multilayer system according to any of the abovementioned claims for producing adhesive tapes, linings and adhesion systems.

10. Process for producing a multilayer system according to claims 1 to 8, characterized in that
(1) the first layer is vulcanized, and then optionally heat-conditioned,
(2) the second layer is produced by aqueous emulsion or suspension polymerization, and then
(3) the first layer and the second layer are brought into contact.

11. Process according to claim 10, characterized in that the contact is achieved by (co)extrusion coating, press coating, solution coating, solution spraying, emulsion coating, calendering, lamination processes or glass/slot extrusion processes or gravure coating, where the second layer is applied to the first layer.
